(19) United States
(12) Patent Application Publication
(10) Pub. No.: US 2010/0096444 A1
(43) Pub. Date: Apr. 22, 2010

(54) IDENTIFICATION SYSTEM

(76) Inventors: Debra J. Cummings, Boca Raton, FL (US); Guy J. Cummings, Boca Raton, FL (US)

Correspondence Address: JOHN C. SMITH, ESQ., 2499 GLADES ROAD, SUITE 113, BOCA RATON, FL, 33431, US

(21) Appl. No.: 12/253,914

(22) Filed: Oct. 17, 2008

(51) Int. Cl. G06F 19/00

(52) U.S. Cl. 235/375

(57) ABSTRACT

An identification system that improves identification of luggage by providing luggage tags that have a photograph of the luggage owner imprinted thereon, and optionally, boarding passes which include a photograph of the passenger imprinted thereon as well. The system can be implemented by printing luggage tags and/or boarding passes at home or office using a personal computer, or alternatively, at the travel agent or airline terminal. For use at an airline terminal, the system can be operated by airline personnel at the check-in counter, or operated by the passenger at a self check-in station. When not operated by airline personnel, the system uses identity verification safeguards which may include smartcards, central database images, or images on external computers, such as home computers, credit card company computers, or other computers which are authorized by password.

### BACKGROUND

1. Technical Field

This invention relates in general to identification systems, and more particularly it relates to a system and method for improving travel security by providing more positive identification of travelers and their luggage. The system automatically prints photographs of the travelers on boarding passes and/or luggage tags. The images can be obtained locally, or from remote secure systems.

2. Background of the Invention

Those who travel by air will typically find that, at best, half of their time is actually spent flying. At least half of the time is spent traveling to and from airports, waiting for check-in, going through security, waiting for takeoff, changing planes at layovers, retrieving their luggage at the destination, and then leaving the airport for their final destination. As a result, travel has become a lengthy exercise that often consumes the better part of the day. When travelers ultimately arrive at their destination, there is often little time left in the day to do anything, and even less inclination to do anything. It would be desirable to make elements of travel more efficient so that the amount of travel time required would be reduced, and the effort invested by travelers would also be reduced.

In addition to the extended amount of time it takes to travel, other problems impact travelers on a frequent basis. In particular, it is very common for luggage to be lost, stolen, or inadvertently taken by another traveler who may have similar luggage. It would be desirable to have a method of accurately identifying the owner of an item of luggage to reduce the possibility of theft, and to reduce the possibility of luggage being accidentally taken by a fellow traveler.

In addition to difficulties created by lost or mistakenly taken luggage, there are other significant issues related to travel. As travelers well know, security has become an important component of travel. Due to the increase in global terrorism, proper identification of passengers has become an important issue for all travelers, especially air travelers. The public has an important interest in properly identifying passengers boarding aircraft. However, systems currently in place to identify passengers typically require passengers to have not only boarding passes, but also other identification available. Typically, identification devices such as driver's licenses, and/or passports, take time to examine. Further, it is common for a passenger to pass through multiple security checkpoints prior to boarding an aircraft. It would be desirable to have an identification system which required fewer items of documentation, and which can be reviewed more rapidly by security personnel.

One attempt to reduce on ground delays for travelers has been to allow passengers to check-in via telephone from any location. This approach is taught by U.S. Pat. No. 7,275,689 to Mak which discloses a passenger check-in system that allows an individual to check-in from any location, on or off the airport premises. Will this system reduces the time taken for one of the travel delays, namely check-in, it does not address issues related to lost or mistakenly taken luggage. Nor does it take into account security issues related to proper identification of passengers.

Another attempt to reduce ground delays has been the use of boarding passes containing images of passengers for more rapid and positive identification of travelers. One such system is taught by U.S. Pat. Nos. 7,239,723 and 6,137,895 to Al-Sheikh which discloses an identity verification system which prints an image of the passenger on the passenger's boarding pass. While this system provides a positive identification, it also requires passengers to have their photograph taken at the time the ticket was purchased. This increases check-in time, and increases work for airline personnel.

In regard to luggage, one attempt has been made to improve identification as disclosed by U.S. Pat. No. 6,698,653 to Diamond et al. This patent discloses an identification system which stores a compressed image of a portion of a passenger's face on chips on boarding passes or luggage tags. The data on the chip is compared to matching data in a data base to verify the individual or the luggage. While improving the positive identification of the luggage owner, it adds substantial cost of the luggage tag, or boarding pass. Further, it requires that the luggage tags and/or boarding passes be printed at the airline, since the chips are complex devices not available for home printing. Recently, the ability provided by most airlines for travelers to print their own boarding passes on their home computers eliminates the use of these chips for many travelers. Further, by capturing only a portion of the passenger's face, identification is not as good as might be. It would be desirable to have a method of using commonly available printers to print boarding passes and/or luggage tags without any special technical features such as chips. In addition, it would also be valuable to have a method of printing an image of the entire face of a boarding pass and luggage tag without requiring any special equipment.

Other attempts have been made to use biometric data for passenger and luggage identification. For example, U.S. Pat. No. 6,108,636 to Yap et al. discloses a system that uses biometric data to identify passengers and their luggage. Likewise, U.S. Pat. No. 5,754,675 to Valadier et al. discloses a system that uses biometric data stored on a card to identify passengers. While these systems achieve their goals, they also require special equipment, and had cost to the system. It would be desirable to have a method of positively identifying a passenger, or the owner of luggage without any special equipment, and without requiring excessive amount of work or time to do so.

While the prior art has addressed various issues related to security, and luggage identification, it has failed to provide a system which provides positive identification of luggage and passengers, which can be implemented in a variety of locations, such as the airport, or at home, and which can be implemented on a wide variety of equipment, including home computers.

### SUMMARY OF THE INVENTION

The invention provides luggage tags that have a photograph of the luggage owner imprinted thereon, and/or boarding passes which include a photograph of the passenger imprinted thereon. The system can be implemented by printing luggage tags and/or boarding passes at home or office using a personal computer, or alternatively, at the travel agent or airline terminal. For use at an airline terminal, the system can be operated by airline personnel at the check-in counter, or operated by the passenger at a self check-in station. When not operated by airline personnel, the system uses identity verification safeguards which may include smartcards, central database images, or images on external computers, such as home computers, which are authorized by password. Further, images on secure external computers, such as government passport databases, department of motor vehicle databases, credit card company databases, can also be accessed by the system.

### BRIEF DESCRIPTION OF THE DRAWINGS

FIG. 1 illustrates a preferred embodiment of a luggage tag with an image of the passenger/luggage owner.

FIG. 2 illustrates a preferred embodiment of a boarding pass with an image of the passenger.

FIG. 3 is a block diagram which illustrates a preferred embodiment of the luggage tag identification system implemented at the ticket counter, self-service kiosk, or remote computer.

FIG. 4 is a block diagram which illustrates a preferred embodiment of the luggage tag identification system with optional boarding pass feature implemented at the ticket counter, self-service kiosk, or remote computer.

FIG. 5 illustrates a preferred embodiment of the luggage tag/boarding pass system implemented on a travel agent's computer or a traveler's home or office computer.

### DETAILED DESCRIPTION OF THE PREFERRED EMBODIMENT

Prior to a discussion of the figures, an overview of the invention will be presented. The invention is an improved method of identifying passengers and their luggage by providing visual identification of the passenger to security personnel, and also providing positive identification of luggage to the luggage owner.

As noted above, it is not uncommon for luggage to be mistakenly taken by another passenger because the luggage bags are similar in style and color. Frequently, when passengers are in a hurry, they may inadvertently take the wrong luggage. The invention reduces the chances of inadvertent misinterpretation of luggage by providing a visual indication of the luggage owner. In particular, the invention provides a photograph, preferably in color, which not only reduces the chance that luggage will be inadvertently taken, it also makes it more convenient for the luggage owner to identify their luggage and exit the airport more quickly.

Another optional feature of the invention is that luggage identification tags using photos can be simultaneously generated with boarding passes that also have a picture of the passenger/luggage owner.

In a first preferred embodiment, the system is implemented at the check-in counter at the airport. A video camera is attached to a ticketing system used at the check-in counter. During the check-in process, the airline personnel would activate the camera to generate an electronic image of the passenger. The system would then print the passenger image on each luggage tag generated for that passenger. In addition, the system would also print the image of the passenger on the boarding pass.

Today, most luggage is fairly similar in appearance, and more likely than not it is black. By having the luggage owner's picture on the luggage tag, it makes it easier for the passenger to identify their luggage. More important, it is much less likely that someone will pick up the wrong luggage item by mistake since the photograph of the luggage owner will be clearly visible on the luggage. The image on the luggage tag helps to avoid a major inconvenience of travel, mainly lost luggage.

An advantage of the invention is that most of the equipment required to implement the invention is already present at the check-in counter. The only additional hardware item required would be a digital camera attached to check-in computer via any convenient method, such as a USB connection. In terms of software, the software would be updated to read the image from the digital camera as part of the check-in process and to output the image to the printer along with the rest of the luggage tag information. Of course, while the image can be printed in grayscale, color images would be preferred since they are more noticeable and easier for security personnel to compare with the passenger.

Another method of implementing the invention is to incorporate a photograph of a passenger into an airlines frequent flyer database. This provides a centrally stored image which can be downloaded without requiring a local camera every time a passenger travels. In fact, the system can even store a luggage tag and/or boarding pass template with a variety of unique passenger information (i.e. photograph, name, address, etc.) for each passenger. When a passenger obtains a luggage tag and/or boarding pass for a particular flight, the template can be downloaded and only flight specific information would need to be added to it.

Alternatively, the image can be previously stored on the airline's computer for return passengers, frequent flyer members, etc. for use on future flights. This can even be used as an exclusive benefit for frequent flyers to entice them to join a particular airlines frequent flyer program. Likewise, when a passenger goes through check-in and requires use of the camera, the image can be stored for future use. For example the image can be associated with a frequent flyer number, with a credit card number, etc. By having a stored image online, the check-in personnel do not have to take time to photograph the passenger, and the check-in process can be expedited. In addition to expediting the check-in process, the boarding procedures can be also improved because once the photograph is on the boarding pass, a separate photo ID would not be required to compare the name and image on a photo ID with the name on a boarding pass. This would further expedite the boarding process.

This same procedure can be used by travel agencies on their computers. This allows them to prepare travel documents such as luggage tags and boarding passes without having their customer physically present.

Another preferred embodiment allows the passenger to generate a luggage tags at home or at their office via personal computer. Of course, verification of identity would be necessary. A number of methods can be used to verify identity. In one alternative method, an individual's photo would be associated with credit card data at a credit card company, and the image would be downloaded when the credit card is used. Another alternative envisions the use of a password by the passenger to access image data and transfer the image to the luggage tag and/or boarding pass.

Another alternative embodiment envisions the invention used in combination with a self-service check-in kiosk at an airport. In this embodiment, they camera needs to be attached to, or incorporated within, presently existing kiosks. In this embodiment, verification is relatively easy since a credit card is typically used to activate an airport check-in kiosk. Once the passenger is identified via the credit card, the camera is activated and the passenger image is printed on the luggage tag and/or the boarding pass. Alternatively, the invention can be implemented without a local camera on the kiosk and downloaded from the credit card company. An advantage provided by using images from the credit card company is that the same credit card can be used for any airline. As a result, the image needs only be stored in a single place and downloaded when needed. A further advantage of this embodiment is that, with or without the invention, a credit card is typically used for identification purposes at this check-in kiosk. Therefore, it requires no extra effort on the part of the traveler.

While the foregoing example used data obtained from secure credit card sites, those skilled in the art recognizes that a variety of other data sources can be used. For example, a driver's license can be used at the kiosk or ticket terminal which would allow the driver's photograph to be downloaded from the state department of motor vehicles. Likewise, a passport can be used to download the passenger's image from government databases. The only requirement is that a proper identification document can be used to access image information at a remote and secure system.

The system described above provides a method of pre-storing images for later use by travelers. However, there are a variety of reasons why they traveler may wish to change the image used for the luggage tag 1. For example, a female traveler may change the color of her hair or the length or style of her hair such that the photo does not provide a good representation of that person. Men may make substantial alterations to their appearance by growing a beard, or shaving one off. Everyone's appearance also changes over time. Individual travelers may wish them time to time to update their stored image such that it properly represents the way they look now. This system provides a method, described below, of optionally uploading a new image in just such cases.

The foregoing discussion talks about individuals who may have images stored on a variety of databases. However, there are many individuals in society who do not have their images stored and easily available databases. For example, small children may not have any information about them in any databases. On the other end of the age spectrum, senior citizens may no longer have a driver's license and there may not be any other database which has their image. In this case, an airline may provide a service program for travelers whereby they upload a photo of the child or senior citizen to their online system (e.g. reservation or frequent-flier system) such that when a child or senior citizen is traveling alone, they can have their image downloaded for printing on luggage tags and boarding passes. In addition, it is also possible to allow third parties such as travel agents to download images from the airline system. This is an additional incentive for individuals to select a particular airline for travel.

It should also be noted that while the foregoing examples discussed the use of this invention in conjunction with a self service kiosk, the invention can also be easily implemented via software operating on a travel agent's computer or at an airline ticket terminal, at a bus station, at a train station, etc. This would allow off-site ticketing facilities, such as travel agents to provide boarding passes and luggage tags with images generated from data at secure remote computers. In fact, software could even be developed, using appropriate known handshake technology, to allow individuals using their home computer to generate boarding passes and luggage tags using this invention.

Having discussed the invention in general, we turn now to a detailed discussion of the drawings.

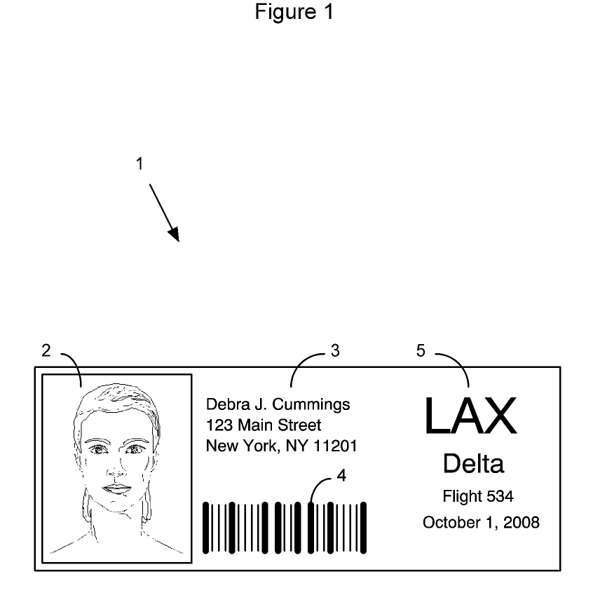

FIG. 1 illustrates a preferred embodiment of a luggage tag 1 with an image 2 of the passenger/luggage owner. Also shown are passenger identification information 3, and destination information numeral 5 (including destination airport code, airline name, flight number, and date. In addition, a barcode 4 is also shown. The barcode 4 and destination information 5 are merely for the use of airport personnel. The passenger identification information 3 and the image 2 are used by both the passenger, and airport personnel.

An advantage provided by the image data is that airport security personnel can more rapidly determine the owner of an item of luggage by comparing the image 2 to the traveler. Likewise, the traveler can more easily identify their luggage at their destination due to the convenience provided by the image on the luggage tag 1. In addition to speeding up the process of retrieving the luggage, the luggage owner is much less likely to pickup someone else's luggage by mistake.

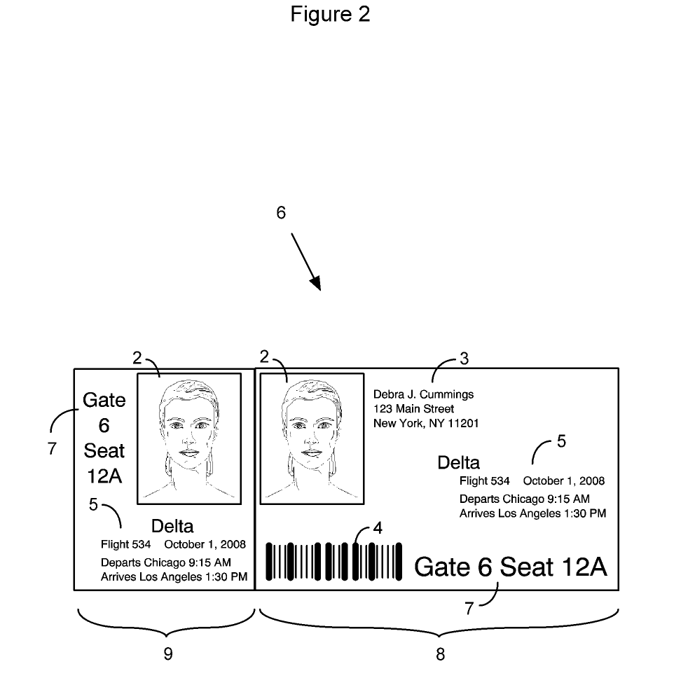

The particular format of data and images illustrated in FIGS. 1 and 2 are used for ease of illustration. However, those skilled in the art will recognize that any suitable format can be used, and the data and images can be oriented in any convenient manner.

FIG. 2 illustrates a preferred embodiment of a boarding pass 6 with an image 2 of the passenger. In a similar fashion to the luggage tag 1, discussed above in regard to FIG. 1, the invention also provides an optional boarding pass 6 with an image 2 of the passenger. The boarding pass with the passenger's image 2 provides a more rapid and positive identification of the passenger. It provides an additional advantage in that by having photo identification on the boarding pass, a separate photo ID is not necessary. This makes the boarding process more convenient and will save time.

Also shown in this figure is additional information, such as gate and seat assignments 7. In addition, the figure also shows the portion of the boarding pass 8 which is taken by airline personnel upon boarding, and passenger stub 9.

In FIGS. 1 and 2, a rudimentary luggage tag 1 and boarding pass 6 were presented to illustrate the features and advantages of the invention. Of course the actual format of a luggage tag may vary from airline to airline and from time to time.

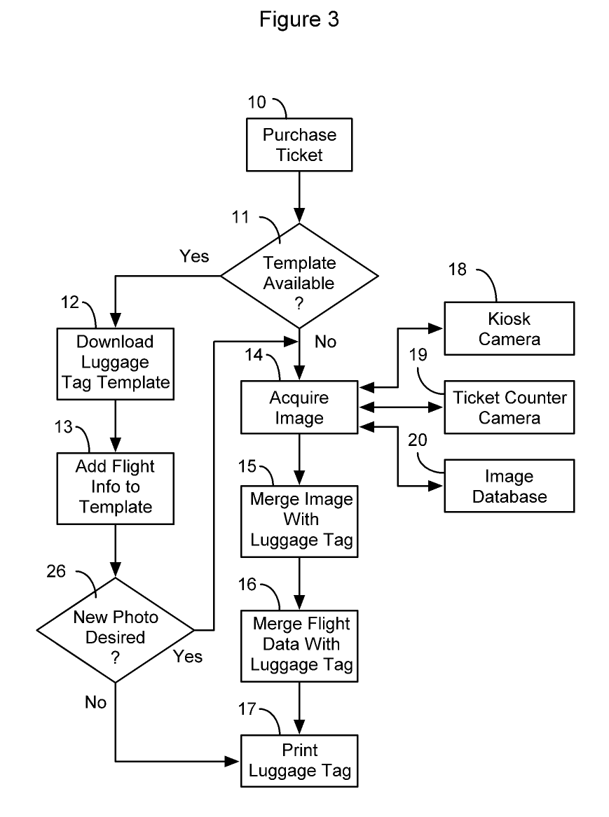

FIG. 3 is a block diagram which illustrates a preferred embodiment of the luggage tag identification system implemented at the ticket counter, at a self-service kiosk, or at a remote computer. In this preferred embodiment, an optional luggage to a template is made available. Through the use of the template, the passenger image 2 and passenger identification information 3 can be pre-stored in a database. Each template is associated with a particular individual. The template is preloaded with an image 2 of the passenger along with passenger identification information 3.

When a passenger purchases a ticket at step 10, the system checks to see if a template is available at step 11. If so, the template is downloaded in step 12 to the system which is generating the luggage tag 1. Since the template has been preconfigured with the passenger image 2 and passenger identification information 3, the only additional information which needs to be added is a destination and flight information at step 13.

Once the template is complete, with image 2 and passenger information 3, the passenger also has the option of updating the image 2. The completed template can be altered at the direction of the passenger by updating the image 2 to reflect the current appearance of the passenger. At step 26, the passenger decides if a new image 2 is necessary. If so, then the next step in the system is to proceed to step 14 to acquire a new image 2. On the other hand, if no new image is desired, the luggage tag 1 can be printed at step 17. An advantage provided by the template is that it eliminates the need to generate an image every time the passenger travels. This will accelerate processing time and eliminate redundant work.

On the other hand, if a template is not available the next step in the process is to acquire an image of the passenger at step 14. This can be done in a variety of ways. If the passenger is getting a boarding pass from airline personnel at the ticket counter, then the airline personnel would capture an image 2 of the passenger via a digital camera 19 attached to the ticketing system. For passengers using self-service kiosks, a digital camera would be incorporated into, or attached to a kiosk. At step 18, the passenger would initiate taking a photograph during the self-service check-in process. Those skilled in the art will recognize that any suitable means can be used to attach the camera to the kiosk. It can be incorporated into the kiosk, attached via a USB cable, etc. Of course, the software which controls the kiosk would have to be modified to add the image acquisition step. The software required to do this is relatively straightforward and does not require further discussion here.

In addition to the image acquisition steps discussed above, images 2 can also stored in an internal airline computer which either is or works with the ticketing system, or the images 2 can be stored on remote computers. For example, when individuals use self-service kiosks, they typically activate it via their credit card. In the event that the credit card company maintains image is of their customers (e.g. images kept for printing on the face of a credit card, etc.), that image can be downloaded along with other identifying information. In addition to credit cards it is also possible to use a driver's license for this purpose. For example, the computer at the Department of Motor Vehicles can be accessed and a photo of the passenger can be downloaded from their system. Likewise, an individual with a passport can use their passport identification number to download a photo from the government system. As can be seen, there are any number of ways an image 2 can be accessed without requiring a camera at the kiosk, or at the ticket counter.

Once an image 2 has been acquired at step 14, the image 2 can then be merged with the luggage tag 1 at step 15. At step 16, other data, such as the flight data can also be merged onto the luggage tag 1. Once the data is assembled for the luggage tag 1, it can be printed at step 17.

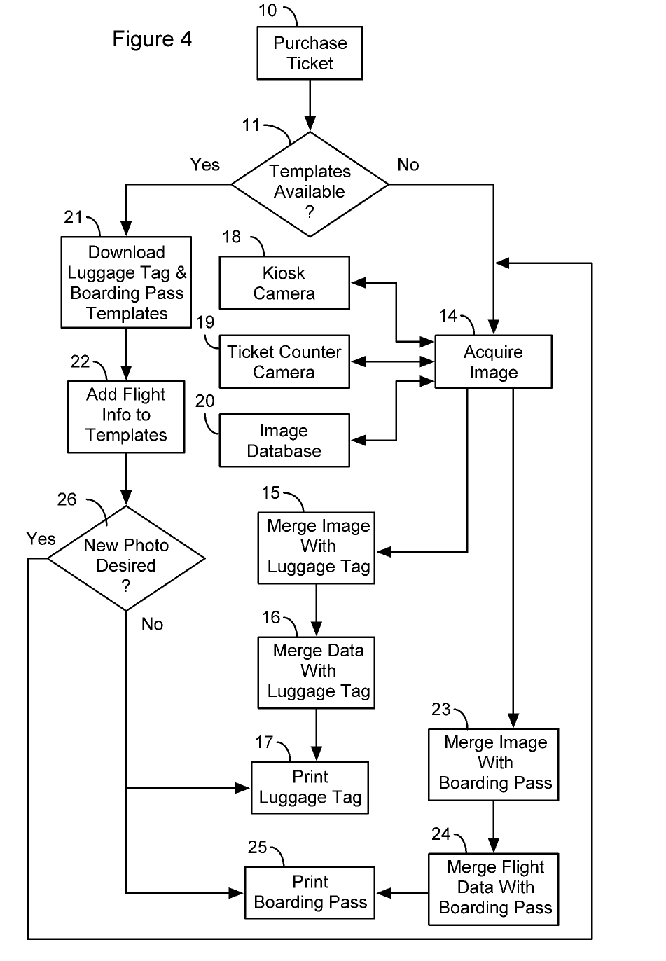

FIG. 4 is a block diagram which illustrates a preferred embodiment of the luggage tag identification system with optional boarding pass feature. This feature can also be implemented at the ticket counter, at a self-service kiosk, or at a remote computer. This embodiment provides templates for both the luggage tag 1 and/or a boarding pass 6. At steps 21, 22, the templates are downloaded and completed. They are then printed as a luggage tag 1 at step 17, or as a boarding pass 6 in step 25.

In the event that a template is not available, the luggage tag 1 will be printed in the same manner discussed in regard to FIG. 3. In addition, this embodiment also provides additional steps 23, 24 which merge the image data, passenger data, and the flight data onto a boarding pass 6 which is then printed at step 25.

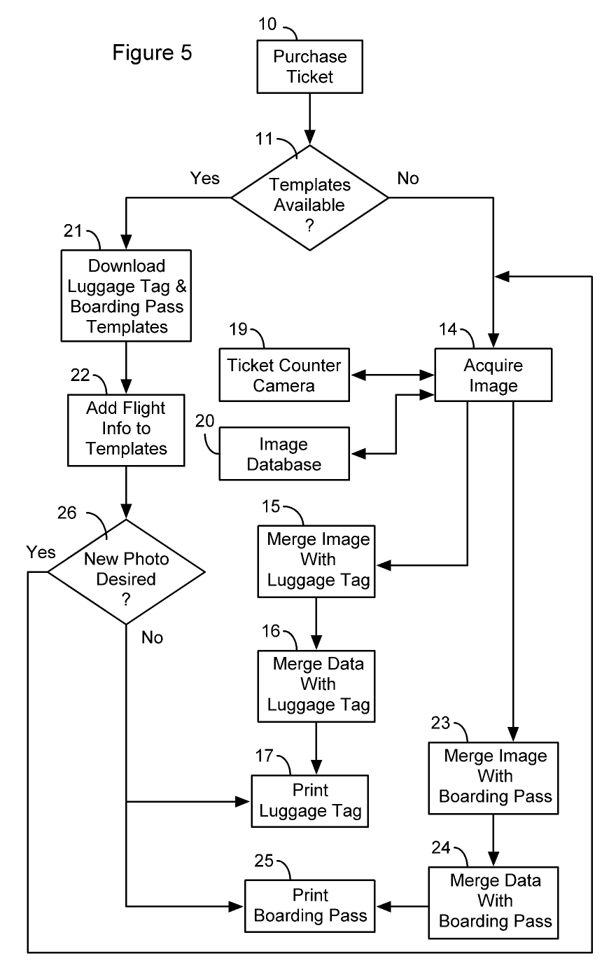

FIG. 5 illustrates a preferred embodiment of the luggage tag/boarding pass system implemented on a travel agent's computer or a traveler's home or office computer. In this embodiment, the kiosk camera is not used. Otherwise, the process is the same as that discussed in regard to FIG. 4. The advantage of the invention is that it allows a travel agent to provide both a boarding pass 6 and the luggage tag 1 for the convenience of the customer. Likewise, an individual can also use this invention in like manner.

Those skilled in the art will realize that while the foregoing discussion has used airline travel to illustrate the features and principles of the invention, the invention can be effectively used by any mode of transportation which requires the use of luggage including air travel, train travel, bus travel, cruise ship travel, etc. The actual mode of transportation can vary. So long as there is a need to identify the owner of luggage using any form of transportation, this invention can provide a benefit to the traveler.

While specific embodiments have been discussed to illustrate the invention, it will be understood by those skilled in the art that variations in the embodiments can be made without departing from the spirit of the invention. For example, the templates can be used or not. The method in which images are stored can vary, etc. Therefore, the invention shall be limited solely by the scope of the claims.

We claim:

1. A luggage identification system, comprising:
data storage for storing passenger image data and passenger identification information;
image input means for acquiring an electronic image of a passenger, and storing the electronic image in the data storage;
means to update the electronic image stored in the data storage; and
a printer for printing a luggage tag having an image of the passenger and passenger identification information;
whereby the luggage tag contains an image of the passenger along with passenger identification information.

2. A system, as in claim 1, further comprising:
a self-service kiosk for outputting luggage tags, wherein:
the image input means is in the self-service kiosk; and
the printer is in the self-service kiosk;
whereby the passenger can input the passenger's image to the system which is then printed on the luggage tag for positive identification of the owner of luggage.

3. A system, as in claim 2, wherein:
the image input means is a camera.

4. A system, as in claim 2, wherein:
the data storage holding the image data is on a remote database.

5. A system, as in claim 4, wherein:
the remote database is on a computer located at a state department of motor vehicles computer, a government passport office computer, a credit card company computer, or an airline computer.

6. A system, as in claim 1, further comprising:
a ticket counter for outputting luggage tags, wherein:
the image input means is in the ticket counter; and
the printer is in the ticket counter;
whereby the passenger's image input to the system is printed on the luggage tag for positive identification of the owner of luggage.

7. A system, as in claim 6, wherein:
the image input means is a camera.

8. A system, as in claim 6, wherein:
the data storage holding the image data is on a remote database.

9. A system, as in claim 8, wherein:
the remote database is on a computer located at a state department of motor vehicles computer, a government passport office computer, a credit card company computer, or an airline computer.

10. A system, as in claim 1, further comprising:
a passenger personal computer for outputting luggage tags, wherein:
the image input means is operatively attached to the passenger personal computer; and
the printer is operatively attached to the passenger personal computer;
whereby the passenger's image input to the system is printed on the luggage tag for positive identification of the owner of luggage.

11. A system, as in claim 10, wherein:
the image input means is a camera.

12. A system, as in claim 10, wherein:
the data storage holding the image data is on a remote database.

13. A system, as in claim 12, wherein:
the remote database is on a computer located at a state department of motor vehicles computer, a government passport office computer, a credit card company computer, or an airline computer.

14. A system, as in claim 1, further comprising:
a travel agent computer for outputting luggage tags, wherein:
the image input means is operatively attached to the travel agent computer; and
the printer is operatively attached to the travel agent computer;
whereby the passenger's image input to the system is printed on the luggage tag for positive identification of the owner of luggage.

15. A system, as in claim 10, wherein:
the image input means is a camera.

16. A system, as in claim 10, wherein:
the data storage holding the image data is on a remote database.

17. A system, as in claim 16, wherein:
the remote database is on a computer located at a state department of motor vehicles computer, a government passport office computer, a credit card company computer, or an airline computer.

18. A method of generating luggage tags, including the steps of:
inputting passenger image data and passenger identification information for a passenger;
outputting the passenger image data and passenger identification information to a luggage tag template; and
using the luggage tag template to print a luggage tag having an image of the passenger and passenger identification information;
whereby the luggage tag contains an image of the passenger and passenger identification information.

19. A method, as in claim 18, including the additional steps of:
acquiring the passenger image data which is input to the system from a camera, or an image database.

20. A method, as in claim 19, including the additional steps of:
the image database is a local database or a remote database which is on a remote computer located at a state department of motor vehicles computer, a government passport office computer, a credit card company computer, or an airline computer.
